(19) United States
(12) Patent Application Publication
(10) Pub. No.: US 2015/0173079 A1
(43) Pub. Date: Jun. 18, 2015

(54) TRANSMISSION DEVICE, COMMUNICATION SYSTEM, TRANSMISSION METHOD, AND TRANSMISSION PROGRAM

(71) Applicant: SHARP KABUSHIKI KAISHA, Osaka-shi (JP)

(72) Inventors: Kazunari Yokomakura, Osaka-shi (JP); Hiroki Takahashi, Osaka-shi (JP); Jungo Goto, Osaka-shi (JP); Osamu Nakamura, Osaka-shi (JP); Yasuhiro Hamaguchi, Osaka-shi (JP)

(73) Assignee: SHARP KABUSHIKI KAISHA, Osaka-shi (JP)

(21) Appl. No.: 14/415,411

(22) PCT Filed: Jul. 5, 2013
(86) PCT No.: PCT/JP2013/068484

§ 371 Date: Jan. 16, 2015

(30) Foreign Application Priority Data
Jul. 17, 2012 (JP) 2012-158999

(51) Int. Cl. H04W 72/04; H04L 27/26

(52) U.S. Cl. CPC H04W 72/0453; H04L 27/2627

(57) ABSTRACT

A transmission device, a communication system, a transmission method, and a transmission program that enhance transmission efficiency and communication quality in CA are provided. Signals of a plurality of bands are transmitted by using a first access scheme for a signal of a first band, which is at least one of the plurality of bands, and by using a second access scheme for a signal of a second band, which is at least another one of the plurality of bands. The first access scheme is a frequency spread scheme and the second access scheme is a frequency division multiplexing scheme.

### TECHNICAL FIELD

The present invention relates to a transmission device, a communication system, a transmission method, and a transmission program.

### BACKGROUND ART

With the proliferation of wireless communication services in which a large amount of data is transmitted and received, upgrading the speed of wireless access networks has been required. Carrier aggregation (CA) may be adopted as a fundamental technology for economically realizing upgraded speeds. CA is a technology that enables broadband (for example, a bandwidth of 10 MHz) transmission by simultaneously using a plurality of frequency bands called component carriers (CCs).

As a scheme for realizing CA, for example, NPL 1 suggests introduction of a new type carrier (NTC) for downlinks (communication from a base station device to a mobile station device). The introduction of NTC makes it easier for a mobile station device to find a cell near the mobile station device.

In this suggestion, it is assumed that various configurations, as well as a configuration in which individual mobile station devices (UE: User Equipment) transmit data to and receive data from one base station device (eNB: eNode B) by using a plurality of CCs, are used as a network configuration for implementing CA. For example, a configuration may be used in which individual mobile station devices transmit data to and receive data from a plurality of base station devices by using different bands. The ranges (cells) covered by radio waves transmitted from the individual base station devices and over which communication can be performed may have different sizes (coverages). Also, the plurality of base station devices may include a large-scale base station device (macro base station) and a small-scale base station device (low power node (LPN)).

### CITATION LIST

### Non Patent Literature

NPL 1: NTT DOCOMO, “Enhanced Cell Identification for Additional Carrier Type”, 3GPP TSG RAN WG1 Meeting #68, Feb. 6-10, 2012, R1-120398, p. 1-4

### SUMMARY OF INVENTION

### Technical Problem

However, in 3GPP LTE (3rd Generation Partnership Project Long Term Evolution), a single access scheme called a discrete Fourier transform spread orthogonal frequency division multiplexing (DFT-S OFDM) scheme is adopted for uplinks (communication from a mobile station device to a base station device). However, characteristics of transmission between a mobile station device and a base station device vary according to the base station device, and thus optimum transmission efficiency and communication quality are not necessary obtained if the DFT-S OFDM scheme is used for all CCs.

The present invention has been made in view of the above-described points, and an object of the present invention is to provide a transmission device, a communication system, a transmission method, and a transmission program for enhancing transmission efficiency and communication quality in CA.

### Solution to Problem

(1) The present invention has been made to solve the above-described problem. According to an aspect of the present invention, a transmission device transmits signals of a plurality of bands by using a first access scheme for a signal of a first band, which is at least one of the plurality of bands, and by using a second access scheme for a signal of a second band, which is at least another one of the plurality of bands.

(2) According to another aspect of the present invention, in the foregoing transmission device, the first access scheme is a frequency spread scheme and the second access scheme is a frequency division multiplexing scheme.

(3) According to another aspect of the present invention, the foregoing transmission device includes a first reference signal assignment unit configured to assign a reference signal to the first band so that only the reference signal is included in contiguous frequencies at a time when the reference signal is assigned, and a second reference signal assignment unit configured to assign a reference signal to the second band so that the reference signal and a data signal are included at a time when the reference signal is assigned.

(4) According to another aspect of the present invention, in the foregoing transmission device, the second reference signal assignment unit is configured to assign the reference signal in a predetermined mapping pattern, and the first reference signal assignment unit is configured to assign the reference signal so that a ratio of a maximum value to a representative value of a power of a transmit signal is smaller than in the mapping pattern.

(5) According to another aspect of the present invention, the foregoing transmission device includes a transmission power controller configured to control a power of the signal of the first band and a power of the signal of the second band by using an index value related to a ratio of a maximum value to a representative value of a power, the index value varying between the first access scheme and the second access scheme.

(6) According to another aspect of the present invention, the foregoing transmission device includes a resource assignment unit configured to control, on the basis of the index value, the number of frequency resources that can be assigned to each of a signal to be transmitted in the first band by using the first access scheme and a signal to be transmitted in the second band by using the second access scheme.

(7) According to another aspect of the present invention, the foregoing transmission device transmits the signals of the plurality of bands by performing spatial multiplexing on the signal of the first band and the signal of the second band by using layers, the number of layers used for the signal of the second band being larger than the number of layers used for the signal of the first band.

(8) According to another aspect of the present invention, a communication system includes a reception device and a transmission device. The transmission device transmits signals of a plurality of bands to the at least two reception devices by using a first access scheme for a signal of a first band, which is at least one of the plurality of bands, and by using a second access scheme for a signal of a second band, which is at least another one of the plurality of bands.

(9) According to another aspect of the present invention, a transmission method for a transmission device includes the step of transmitting, with the transmission device, signals of a plurality of bands by using a first access scheme for a signal of a first band, which is at least one of the plurality of bands, and by using a second access scheme for a signal of a second band, which is at least another one of the plurality of bands.

(10) According to another aspect of the present invention, a transmission program causes a computer of a transmission device to execute a procedure of transmitting, with the transmission device, signals of a plurality of bands by using a first access scheme for a signal of a first band, which is at least one of the plurality of bands, and by using a second access scheme for a signal of a second band, which is at least another one of the plurality of bands.

### Advantageous Effects of Invention

According to the present invention, transmission efficiency in CA is enhanced.

### BRIEF DESCRIPTION OF DRAWINGS

FIG. 1 is a conceptual diagram illustrating a communication system according to a first embodiment of the present invention.

FIG. 2 is a conceptual diagram illustrating an example of CCs according to the embodiment.

FIG. 3 is a schematic diagram illustrating the configuration of a mobile station device according to the embodiment.

FIG. 4 includes diagrams illustrating examples of assignment information according to the embodiment.

FIG. 5 is a schematic diagram illustrating the configuration of a mobile station device according to a second embodiment of the present invention.

FIG. 6 is a table illustrating an example of MPR according to the embodiment.

FIG. 7 is a table illustrating an example of CM according to the embodiment.

FIG. 8 is a flowchart illustrating a process of calculating transmission power control values according to the embodiment.

FIG. 9 is a schematic diagram illustrating the configuration of a mobile station device according to modification example 2 of the embodiment.

FIG. 10 is a flowchart illustrating a process of adjusting frequency resources according to the modification example.

FIG. 11 is a schematic diagram illustrating the configuration of a mobile station device according to a third embodiment of the present invention.

### DESCRIPTION OF EMBODIMENTS

### First Embodiment

Hereinafter, a first embodiment of the present invention will be described with reference to the drawings.

An example described below is an example configuration of a case where a mobile station device communicates with the same partner device (not illustrated) by performing CA by using two CCs mainly in uplink.

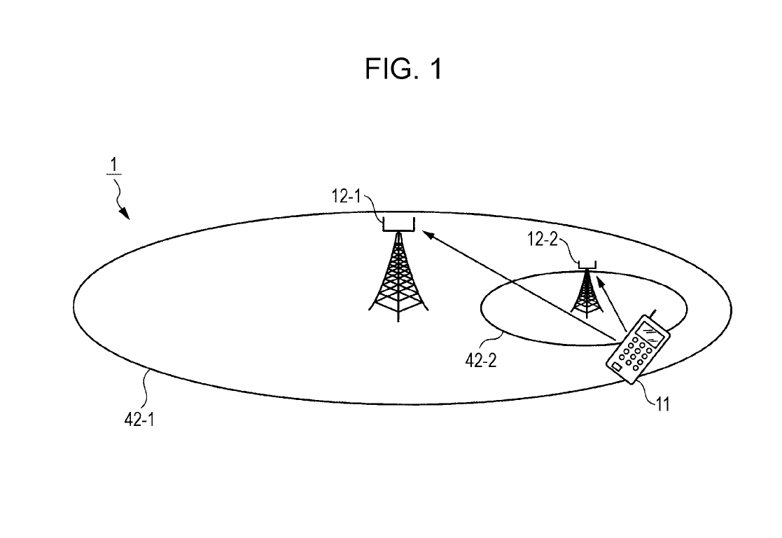

FIG. 1 is a conceptual diagram illustrating a communication system 1 according to this embodiment.

The communication system 1 according to this embodiment includes a mobile station device (transmission device) 11 and two base station devices (reception devices) 12-1 and 12-2.

The mobile station device 11 transmits data signals to the base station devices 12-1 and 12-2 by using CCs of different frequency bands. In the following description, the CC used for transmitting a data signal to the base station device 12-1 is called a first CC, and the CC used for transmitting a data signal to the base station device 12-2 is called a second CC.

The base station device 12-1 is a macro base station (macro eNB). A macro base station is a base station device that has a relatively large cell (with a radius of several hundred meters to several kilometers) which is covered by radio waves and over which communication can be performed. In FIG. 1, the horizontally long ellipse centered on the base station device 12-1 represents a cell 42-1 of the base station device 12-1. The base station device 12-1 transmits a data signal received from the mobile station device 11 to a partner device via a trunk network (core network, not illustrated). Also, the base station device 12-1 transmits a data signal received from the partner device to the mobile station device 11.

The base station device 12-2 is an LPN. An LPN is a base station device that has a cell smaller than a cell of a macro base station (for example, a radius of several meters to several hundred meters). Examples of an LPN include a femto cell, a pico cell, a Home Node B (HNB), and REMOTE Radio Head (RRH). In FIG. 1, the horizontally long ellipse centered on the base station device 12-2 represents an area (cell) 42-2 covered by the base station device 12-2. The base station device 12-2 transmits a data signal received from the mobile station device 11 to a partner device via a trunk network (core network, not illustrated). Also, the base station device 12-2 transmits a data signal received from the partner device to the mobile station device 11.

In the communication system 1, part of the band of the second CC 13-2 may be offloaded to narrow the bandwidth in a case where radio resources, such as an available time, frequencies, and spatial resources, of the base station device 12-2 are smaller than those of the base station device 12-1, depending on traffic conditions. Offload means that part of communication that is currently being performed is performed by another communication means in a case where an amount of communication that is being performed by using certain communication means exceeds a certain amount. At this time, the radio resources for the first CC 13-1 may be expanded by an amount of decrease in the radio resources for the second CC 13-2. In coordinated communication (CoMP: Coordinate Multi-Point transmission and reception) between the base station devices 12, handover may be performed so that communication is continuously performed even if the mobile station device 11 moves out of the range of the cell 42-1. Handover means switching of a base station device to which a signal is to be transmitted. The base station device 12-1 uses, as a clue of mobility control for determining whether or not handover needs to be performed, measurement report information (measurement report) received from the mobile station device 11. The measurement report information includes information obtained through measurement performed by the mobile station device 11, that is, an index indicating communication quality, for example, reception power in downlink. Here, the mobile station device 11 may transmit measurement report information to the base station device 12-1 by using the first CC 13-1, and may transmit transmission data to the base station device 12-2 by using the second CC 13-2.

### (Example of CCs)

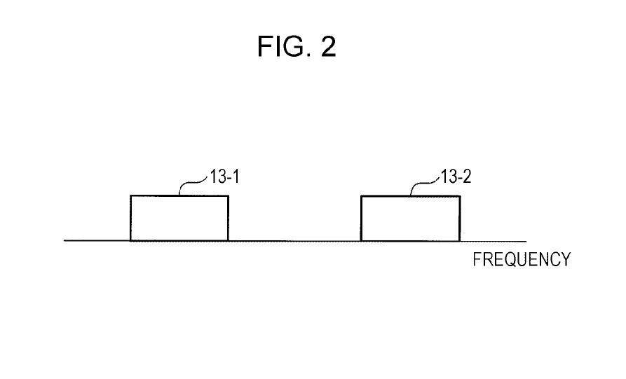

FIG. 2 is a conceptual diagram illustrating an example of CCs according to this embodiment.

In FIG. 2, the horizontal axis represents frequency, and the two horizontally long rectangles represent the first CC 13-1 and the second CC 13-2, respectively. The first CC 13-1 and the second CC 13-2 have different frequency bands. For example, the first CC 13-1 has a frequency band of 2 GHz, whereas the second CC 13-2 has a frequency band of 3.5 GHz. Such CA in which CCs of frequency bands isolated from each other are used is called inter-band CA.

### (Configuration of Mobile Station Device)

Next, the configuration of the mobile station device 11 according to this embodiment will be described.

The mobile station device 11 described below is an example of the configuration of transmitting a part of a transmit signal by using the first CC 13-1 and the DFT-S-OFDM scheme, and transmitting the other part of the transmit signal by using the second CC 13-2 and the OFDM (Orthogonal Frequency Division Multiplexing) scheme.

The DFT-S-OFDM scheme is one of single-carrier transmission schemes for transmitting transmission data by using a single carrier (carrier wave) by performing frequency spread on the transmission data. The DFT-S-OFDM scheme is also called an SC-FDMA (Single Carrier Frequency Division Multiple Access) scheme.

On the other hand, the OFDM scheme is one of multi-carrier transmission schemes. A multi-carrier transmission scheme is a scheme for performing transmission by combining a plurality of carriers having different frequency bands. In this embodiment, the second CC 13-2 is formed of the plurality of carriers.

### (Configuration of Mobile Station Device)

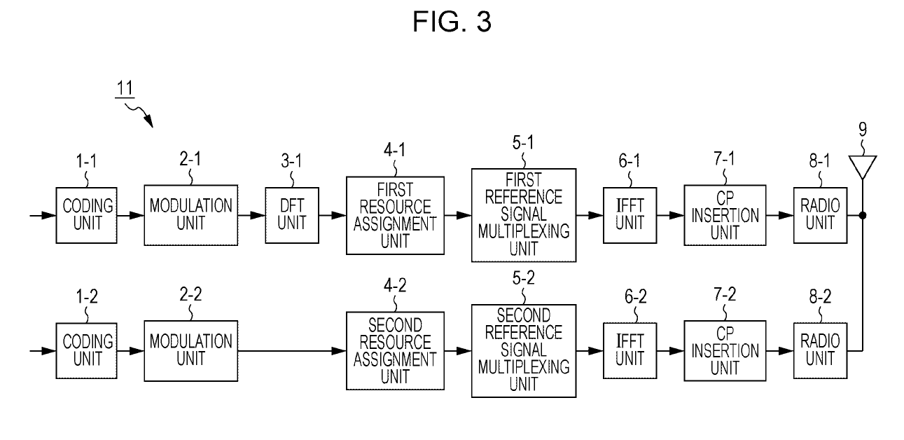

FIG. 3 is a schematic diagram illustrating the configuration of the mobile station device 11 according to this embodiment.

In FIG. 3, the configurations for respectively transmitting transmit signals by using the first CC 13-1 (FIG. 2) and the second CC 13-2 (FIG. 2) are distinguished from each other by -1 and -2 added to the ends of individual reference numerals.

The mobile station device 11 includes coding units 1-1 and 1-2, modulation units 2-1 and 2-2, a DFT unit 3-1, a first resource assignment unit 4-1, a second resource assignment unit 4-2, a first reference signal multiplexing unit 5-1, a second reference signal multiplexing unit 5-2, IFFT units 6-1 and 6-2, CP insertion units 7-1 and 7-2, radio units 8-1 and 8-2, and an antenna 9.

The coding units 1-1 and 1-2 respectively receive information bits that constitute a part and the residual part of user data to be transmitted to a partner device. The coding units 1-1 and 1-2 respectively perform error correction coding on the received information bits to generate coded bits. The coding units 1-1 and 1-2 respectively output the generated coded bits to the modulation units 2-1 and 2-2.

The modulation units 2-1 and 2-2 respectively modulate the coded bits received from the coding units 1-1 and 1-2 to generate modulation signals. The modulation units 2-1 and 2-2 may use a known scheme, for example, QPSK (Quaternary Phase Shift Keying), 16QAM (Quadrature Amplitude Modulation), or the like. The modulation units 2-1 and 2-2 respectively output the generated modulation signals to the DFT unit 3-1 and the second resource assignment unit 4-2.

The DFT unit 3-1 performs discrete Fourier Transform (DFT) on the modulation signal received from the modulation unit 2-1 to transform the modulation signal into a modulation signal in the frequency domain (a frequency-domain signal). The DFT unit 3-1 outputs the frequency-domain signal obtained through the transform to the first resource assignment unit 4-1.

The first resource assignment unit 4-1 assigns the frequency-domain signal received from the DFT unit 3-1 to resource elements (REs), for each symbol, within each resource block (RB) with reference to assignment information. Such assignment is called “mapping”. An RB is the unit of assigning a frequency band (radio resource). That is, an RB is a candidate frequency band that can be assigned. One RB has a bandwidth of 180 kHz, for example, and is constituted by twelve REs. An RE is the smallest unit of radio resources and is also called a subcarrier. An RE has a bandwidth of 15 kHz, for example. A slot time is a time at which an RB is assigned. A slot length, that is, a time period occupied by one RB, is 0.5 ms, for example. Seven REs occupy one RB on the time axis. Assignment information is information indicating the REs as an assignment destination for each symbol time about a set of symbols constituting an input signal. An example of assignment information will be described below.

The first resource assignment unit 4-1 uses the frequency-domain signal generated by the DFT unit 3-1, and thereby peak power of a transmit signal can be suppressed compared to the case of using a modulation signal directly received from the modulation unit 2-1. However, power cannot be controlled for each subcarrier.

The first resource assignment unit 4-1 outputs a frequency signal that has been generated by assigning it to the REs to the first reference signal multiplexing unit 5-1.

The second resource assignment unit 4-2 assigns the modulation signal received from the modulation unit 2-2 to REs, for each slot time, within each RB with reference to assignment information, like the first resource assignment unit 4-1. Here, the second resource assignment unit 4-2 directly receives, from the modulation unit 2-2, the frequency-domain signal on which DFT has not been performed.

The second resource assignment unit 4-2 outputs a frequency signal that has been generated by assigning the modulation signal to the REs to the second reference signal multiplexing unit 5-2.

The first reference signal multiplexing unit 5-1 and the second reference signal multiplexing unit 5-2 respectively assign reference signals (also called “pilot signals”) to the frequency signals received from the first resource assignment unit 4-1 and the second resource assignment unit 4-2 with reference to assignment information, so as to multiplex the reference signals. The assigned reference signals may be, for example, demodulation reference signals (DMRSs). DMRSs are reference signals that are referred to in order to demodulate reception signals of individual CCs in the base station devices 12-1 and 12-2. The assigned reference signals may further include a sounding reference signal (SRS). An SRS is a reference signal for estimating a transmission function of a channel from the mobile station device 11 to the base station devices 12-1 and 12-2. That is, this reference signal is used to determine frequency scheduling and MCS (Modulation and Coding Scheme), and to select a precoding matrix.

The first reference signal multiplexing unit 5-1 and the second reference signal multiplexing unit 5-2 respectively output the frequency signals onto which the reference signals have been multiplexed to the IFFT units 6-1 and 6-2.

The IFFT units 6-1 and 6-2 respectively perform inverse fast Fourier transform (IFFT) on the frequency signals received from the first reference signal multiplexing unit 5-1 and the second reference signal multiplexing unit 5-2, so as to transform the frequency signals into time signals. The IFFT units 6-1 and 6-2 respectively output the time signals obtained through the transform to the CP insertion units 7-1 and 7-2.

The CP insertion units 7-1 and 7-2 respectively insert a cyclic prefix (CP) into the time signals received from the IFFT units 6-1 and 6-2. A CP is a signal of a predetermined section from the end of a time signal. The CP insertion units 7-1 and 7-2 respectively insert the CP into the heads of the time signals. The CP insertion units 7-1 and 7-2 respectively output the time signals to which the CP has been inserted to the radio units 8-1 and 8-2.

The radio units 8-1 and 8-2 up-convert the time signals received from the CP insertion units 7-1 and 7-2 so that the base frequencies thereof become carrier frequencies corresponding to the first CC and the second CC, respectively, and thereby generate radio signals. The radio units 8-1 and 8-2 respectively output the generated radio signals to the antenna 9. Accordingly, transmission data is transmitted by using the first CC and the DFT-S-OFDM scheme, and transmission data is transmitted by using the second CC and the OFDM scheme.

In this embodiment, an access scheme other than the DFT-S-OFDM scheme may be used as long as transmission data is transmitted by using the first CC by performing frequency spread. For example, a Clustered DFT-S-OFDM scheme may be used. The Clustered DFT-S-OFDM scheme is a scheme in which a frequency-domain signal is divided into a plurality of clusters, the individual clusters are assigned to frequency bands that are selected in accordance with a channel state, and a transmit signal generated thereby is transmitted.

In this embodiment, any multi-carrier transmission scheme of transmitting transmission data by using the second CC and a plurality of carriers (carrier waves) may be used, as well as the OFDM scheme. As a scheme of transmitting transmission data by using the second CC, another access scheme, for example, an MC-CDM (Multi-Carrier Code Division Multiplexing) scheme may be used.

Here, in the case of performing communication with a base station device serving as a reception point that is the closest to the mobile station device 11 (in the example in FIG. 1, the base station device 12-1), a direct wave is dominant and a sufficient level of a receive signal may be acquired, and thus variations in phase caused by propagation decrease. Therefore, a difference in access scheme has a relatively small influence on restrictions imposed by peak power of a receive signal received by the base station device 12-2 from the mobile station device 11. Thus, in this embodiment, the mobile station device 11 uses a multi-carrier transmission scheme (for example, OFDM) for a signal to be transmitted to the base station device 12-2 by using the second CC 13-2. Accordingly, a large capacity can be obtained, and the amount of a reference signal in the second CC can be relatively decreased, as will be described below. Further, the amount of processing can be decreased because it is not necessary to perform frequency spread (for example, frequency spread using DFT), unlike for the signal transmitted to the base station device 12-1 by using the first CC.

### (Examples of Assignment Information)

Next, examples of assignment information will be described. In the following description, examples of a time (symbol time) and a frequency (subcarrier) to which a reference signal is mapped in one RB will be given.

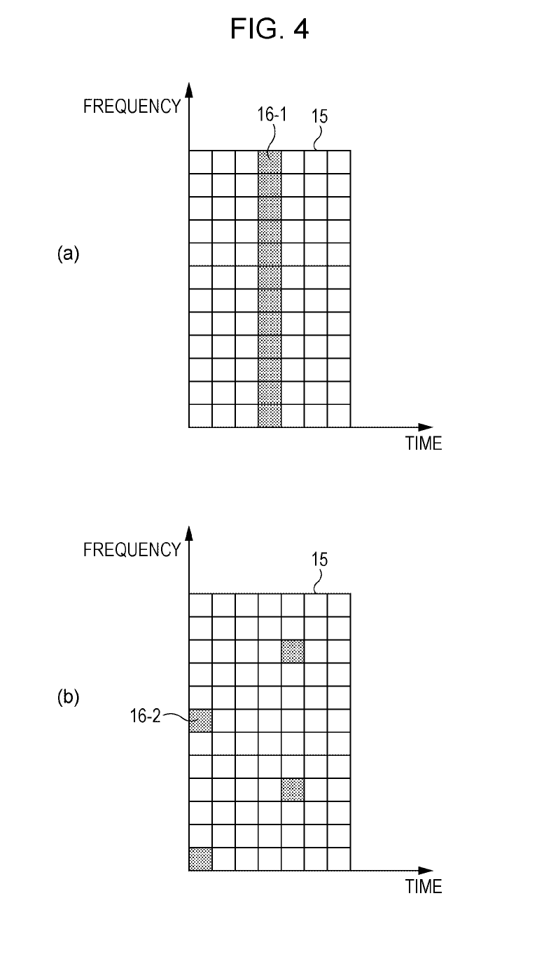

FIG. 4 includes diagrams illustrating examples of assignment information according to this embodiment.

In parts (a) and (b) of FIG. 4, the horizontal axis represents time, the vertical axis represents frequency, and a rectangle drawn with a bold line represents an RB 15. Each square drawn with a thin line represents an RE. The RB 15 includes twelve REs in the frequency domain and seven REs in the time domain. The shaded portions represent an RE 16-1 and an RE 16-2 to which a reference signal is assigned. The portions that are not shaded represent REs to which a frequency-domain signal or modulation signal based on user data is assigned.

Part (a) of FIG. 4 illustrates an example of mapping of a reference signal that is to be transmitted by using the first CC.

In part (a) of FIG. 4, the RE 16-1 occupies all the REs in the fourth column from the left. That is, it is illustrated that the first reference signal multiplexing unit 5-1 assigns only a reference signal over the contiguous frequency bands to which the reference signal can be assigned and does not assign other signals at the time corresponding to this column. Also, it is illustrated that the first reference signal multiplexing unit 5-1 does not assign a reference signal and exclusively assigns other signals at the other times. Accordingly, a situation can be prevented from occurring where the same type of signals are assigned to each time and frequency spread causes mixture of signal types. Thus, a characteristic can be utilized in which a ratio (relative value) of a maximum value (peak) to an average value of power in time variation in the scheme of performing frequency spread, such as the DFT-S-OFDM scheme, is low.

An index of a ratio of a maximum value to an average value of power may be, for example, PAPR (Peak to Average Power Ratio), CM (Cubic Metric), or the like. CM is a ratio of a time average value of the cube of a signal value of a target signal to a time average value of the cube of a signal value of a base signal, and it is known that back-off that is approximate to the reality can be calculated. As PAPR or CM decreases, a ratio of a maximum value to an average value (representative value) of power decreases. As PAPR or CM increases, a ratio of a maximum value to an average value of power increases. As a ratio of a maximum value to an average value of power increases, an amplification factor of a power amplifier that amplifies a transmit signal is more likely to be saturated. That is, a transmit signal is not properly amplified and communication quality is degraded. Thus, the degradation of communication quality can be avoided by decreasing a ratio of a maximum value to an average value of power as described above. In this embodiment, a signal whose amplitude slightly fluctuates may be used as a reference signal, that is, for example, a Zadoff-Chu sequence may be used as a signal having low PAPR or CM. The Zadoff-Chu sequence is a signal sequence in which signal values are distributed on a unit circle where the absolute value of the amplitude is a constant value.

Part (b) of FIG. 4 illustrates an example of mapping of a reference signal that is to be transmitted by using the second CC.

Part (b) of FIG. 4 illustrates that REs 16-2 are mapped in a distributed manner over all frequency bands at an interval of four subcarriers every five symbols. That is, it is illustrated that the second reference signal multiplexing unit 5-2 assigns a reference signal in a distributed manner over the entire frequency band to which the reference signal can be assigned, at a predetermined time interval and frequency interval. The reference signal assigned in this manner is called a scattered pilot (SP). A scattered pilot is mapped at a constant frequency interval and time interval, and is thus easily detected on a reception side. Thus, it is sufficient that the ratio of a reference signal is lower than in other mapping, and thus transmission efficiency can be enhanced by decreasing overhead.

As described above, in this embodiment, a transmit signal is transmitted by using access schemes that are different in individual CCs. Thus, transmission efficiency and communication quality can be enhanced by utilizing the advantages of individual access schemes and compensating for the disadvantages. That is, transmission is performed by performing frequency spread in the first CC, and multi-carrier transmission is performed for the second CC. Thus, the portion of a reference signal in the overhead can be reduced to enhance transmission efficiency in CA. The transmission efficiency and communication quality in CA can further be enhanced by assigning only a reference signal to all the contiguous frequency bands in the first CC and by mapping a reference signal at a constant frequency interval and time interval in the second CC.

### Second Embodiment

Next, regarding a second embodiment of the present invention, the same configuration or process is denoted by the same reference numeral, and the description thereof is given by quoting it from the first embodiment. This embodiment is an embodiment of performing transmission power control (TPC) in accordance with an access scheme of each CC.

A communication system 2 (not illustrated) according to this embodiment includes a mobile station device 21 instead of the mobile station device 11 of the communication system 1 (see FIG. 1).

### (Configuration of Mobile Station Device)

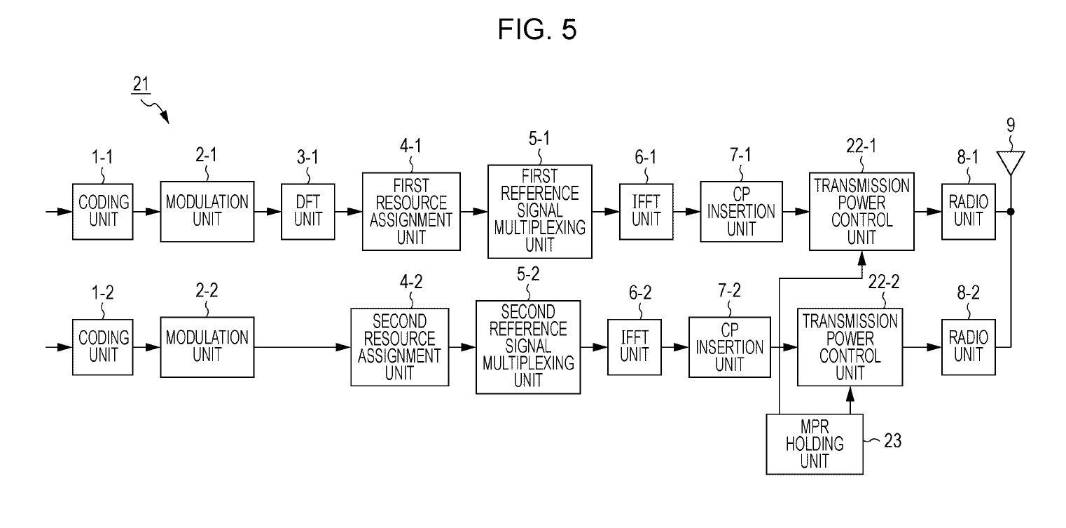

FIG. 5 is a schematic diagram illustrating the configuration of the mobile station device 21 according to this embodiment.

The mobile station device 21 includes two transmission power control units 22-1 and 22-2 and an MPR holding unit 23, in addition to the components of the mobile station device 11 (see FIG. 1).

The transmission power control units 22-1 and 22-2 calculate transmission power control values in accordance with the access schemes of individual CCs, multiply the calculated transmission power control values by time signals received from the CP insertion units 7-1 and 7-2, and thereby respectively control powers. The transmission power control units 22-1 and 22-2 respectively output the time signals for which powers have been controlled to the radio units 8-1 and 8-2. A process of calculating a transmission power control value will be described below.

The MPR holding unit 23 stores MPR (Maximum Power Reduction) in advance in association with an access scheme. MPR is an index value indicating the magnitude of a maximum transmission power according to a transmission scheme, and is specifically a relative value (an amount of reduction) with respect to the maximum transmission power of the mobile station device 21. That is, MPR is an amount of correction that varies according to an access scheme and that is about the maximum value of power that does not cause saturation of a transmit signal in an amplifier.

### (Example of MPR)

Next, an example of MPR held by the MPR holding unit 23 will be described.

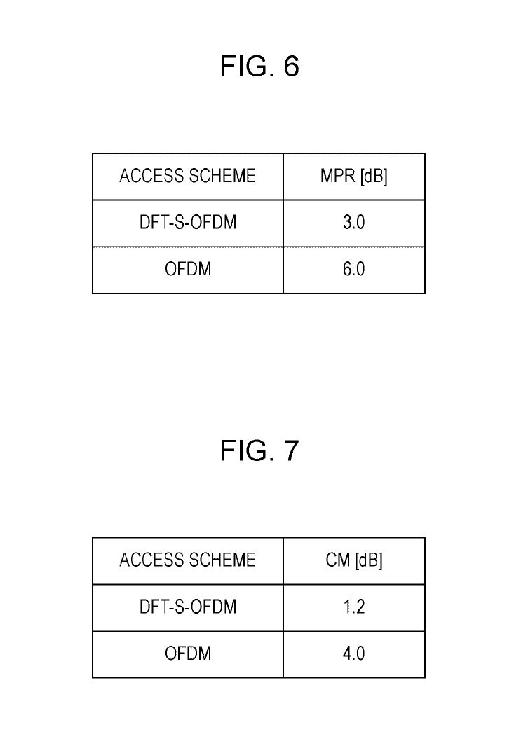

FIG. 6 is a table illustrating an example of MPR according to this embodiment.

FIG. 6 illustrates that MPR is 3.0 dB in a case where the DFT-S-OFDM scheme is used as an access scheme, and MPR is 6.0 dB in a case where the OFDM scheme is used as an access scheme.

### (Example of CM)

Other than MPR, CM may be used as an index value related to peak power. CM is also a value that depends on an access scheme. In this embodiment, a CM holding unit (not illustrated) that holds CM may be provided instead of the MPR holding unit 23 that holds MPR, and transmission power control and resource adjustment that will be described below may be performed by using CM instead of MPR.

FIG. 7 is a table illustrating an example of CM according to this embodiment.

FIG. 7 illustrates that CM is 1.2 dB in a case where the DFT-S-OFDM scheme is used as an access scheme, and CM is 4.0 dB in a case where the OFDM scheme is used as an access scheme. However, in a case where the DFT-S-OFDM scheme is used as an access scheme, CM also depends on a modulation scheme. The value of CM in the DFT-S-OFDM scheme illustrated in FIG. 7 is a value in a case where QPSK is used as a modulation scheme. As CM decreases, a ratio of a maximum value to an average value of power decreases. CM and MPR are index values related to the level of the peak, like PAPR, but both do not necessarily match each other.

### (Process of Calculating Transmission Power Control Values)

A description will be given of a process of calculating transmission power control values in the transmission power control units 22-1 and 22-2. Here, MPR is used as an index value related to peak power, for example.

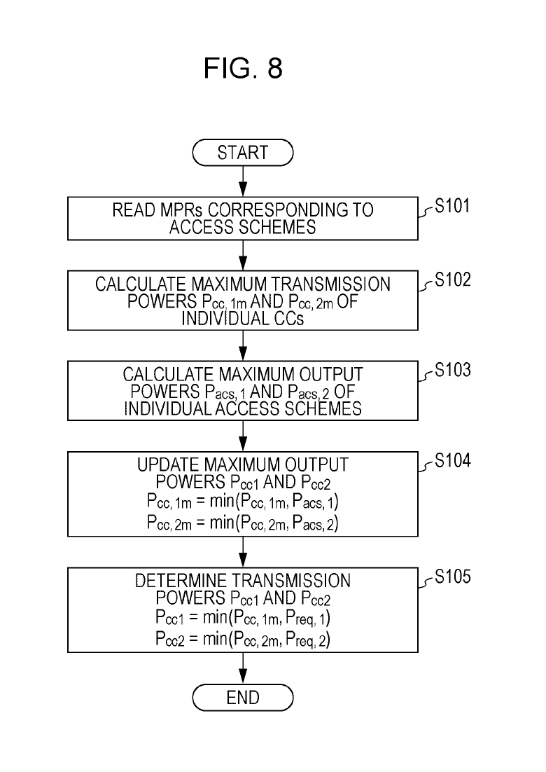

FIG. 8 is a flowchart illustrating a process of calculating transmission power control values according to this embodiment. (Step S101) The transmission power control units 22-1 and 22-2 respectively read MPRs corresponding to the access schemes of the individual CCs from the MPR holding unit 23. Here, the transmission power control unit 22-1 reads 3.0 dB as MPR corresponding to the DFT-S-OFDM scheme, which is the access scheme of the first CC. The transmission power control unit 22-2 reads 6.0 dB as MPR corresponding to the OFDM scheme, which is the access scheme of the second CC. After that, the process proceeds to step S102. (Step S102) The transmission power control units 22-1 and 22-2 respectively divide a predetermined maximum transmission power of the mobile station device 21 (for example, 23 dBm) by the number of CCs used by the mobile station device 21 (for example, 2), so as to calculate maximum transmission powers P_{cc,1m} and P_{cc,2m} of the individual CCs (for example, 20 dBm). After that, the process proceeds to step S103. (Step S103) The transmission power control units 22-1 and 22-2 respectively divide a predetermined saturation output power of an amplifier used for the individual CCs (for example, 24 dBm) by the MPRs that have been respectively read, so as to calculate maximum output powers P_{acs,1} and P_{acs,2} of the individual access schemes (for example, 21 dBm (DFT-S-OFDM scheme) and 18 dBm (OFDM scheme)). After that, the process proceeds to step S104.

(Step S104) The transmission power control units 22-1 and 22-2 update the maximum transmission powers of the individual CCs to the smaller values min (P_{cc,1m}, P_{acs,1}) and min (P_{cc,2m}, P_{acs,2}) among the maximum transmission powers of the individual CCs and the maximum output powers of the individual access schemes that have been calculated (for example, 20 dBm (first CC) and 18 dBm (second CC)). After that, the process proceeds to step S105. (Step S105) The transmission power control units 22-1 and 22-2 determine the smaller values min (P_{cc,1m}, P_{req,1}) and min (P_{cc,2m}, P_{req,2}) among the maximum transmission powers of the individual CCs and the required transmission powers of the individual CCs that have been calculated to be the transmission powers P_{cc1} and P_{cc2} of the individual CCs. The required transmission powers are transmission powers that are necessary for the base station devices 12-1 and 12-2 corresponding to the individual CCs to receive signals with certain reception powers. The transmission power control units 22-1 and 22-2 calculate the determined transmission powers P_{cc1} and P_{cc2} as transmission power control values. After that, the process ends.

In the above-described example, the transmission power control units 22-1 and 22-2 determine the maximum values of transmission powers of the individual CCs, compare values obtained by subtracting MPRs from saturation powers of the individual CCs, and determine the maximum transmission powers. Even if the transmission scheme varies, the base station devices 12-1 and 12-2 are able to obtain sufficient reception power, and unnecessary signal radiation, such as out-of-band radiation, can be suppressed.

### Modification Example 1

Next, a modification example (modification example 1) according to this embodiment will be described.

In a multi-carrier scheme, which is a scheme of transmitting a signal by using a second CC, MPR or CM is generally larger than in a single-carrier scheme. Thus, a maximum transmission power is limited to the transmission power of the single-carrier scheme, and as a result, a difference in reception power occurs between CCs in a case where an access scheme varies.

In this modification example, the transmission power control units 22-1 and 22-2 determine transmission powers so that reception powers obtained by subtracting MPR become equal in all the CCs.

Specifically, in the above-described step S105, the transmission power control units 22-1 and 22-2 determine a minimum value P_{cc} on the basis of the maximum transmission powers P_{cc,1m} and P_{cc,2m} of the individual CCs, and the determined minimum value P_{cc} is used in common instead of the maximum transmission powers P_{cc,1m} and P_{cc,2m} that are targets to be compared with required transmission powers. Accordingly, the common value P_{cc} is used as the maximum transmission powers, and thus a difference in reception power does not occur between the CCs.

### Modification Example 2

Next, another modification example (modification example 2) according to this embodiment will be described.

In this modification example, the number of REs is controlled so that the reception powers become equal between the CCs.

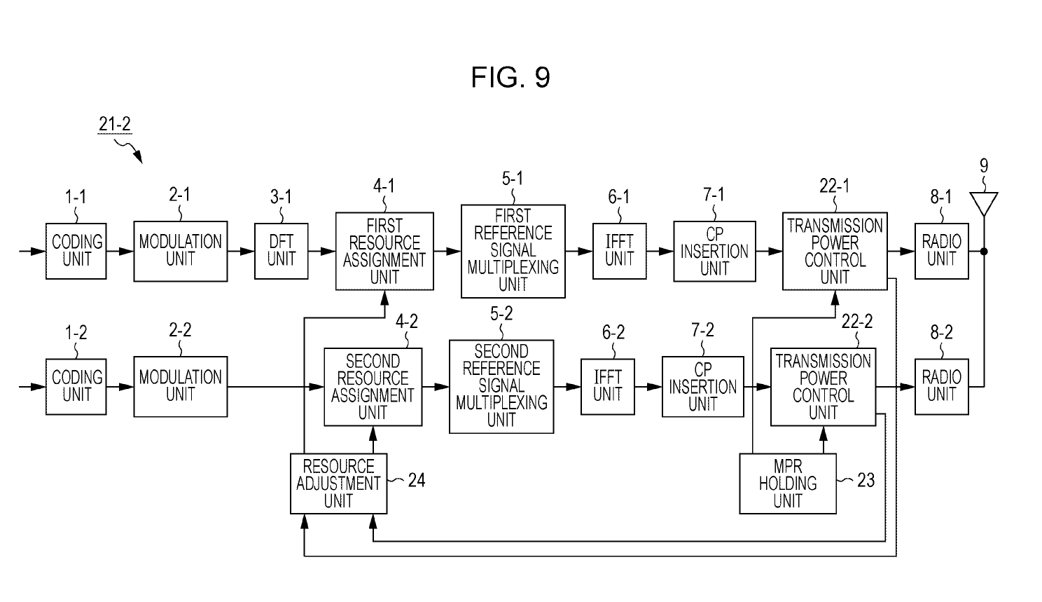

FIG. 9 is a schematic diagram illustrating the configuration of a mobile station device 21-2 according to this modification example.

The mobile station device 21-2 includes a resource adjustment unit 24 in addition to the components of the mobile station device 21 (see FIG. 5).

The resource adjustment unit 24 receives the maximum transmission powers P_{cc,1m} and P_{cc,2m} of the individual CCs updated by the transmission power control units 22-1 and 22-2 (see step S104), and calculates, on the basis of the received maximum transmission powers P_{cc,1m} and P_{cc,2m}, the numbers of frequency resources available for transmission. The resource adjustment unit 24 outputs the numbers of frequency resources calculated for the individual CCs to the first resource assignment unit 4-1 and the second resource assignment unit 4-2, respectively. The first resource assignment unit 4-1 and the second resource assignment unit 4-2 each determine assignment information for assigning a frequency-domain signal and a modulation signal to the frequency resources the number of which has been received from the resource adjustment unit 24. The first resource assignment unit 4-1 and the second resource assignment unit 4-2 each assign the frequency-domain signal and the modulation signal input thereto to the frequency resources by using a known method on the basis of the determined assignment information. The first resource assignment unit 4-1 and the second resource assignment unit 4-2 transmit the determined assignment information to the base station devices 12-1 and 12-2, respectively.

### (Process of Adjusting Frequency Resources)

In this modification example, the above-described frequency resources may be any of REs, RBs, and an RB group constituted by a predetermined number of RBs, and are not limited thereto. Hereinafter, a more detailed description will be given of a process of adjusting frequency resources. Here, REs are used as frequency resources and MPR is used as an index value related to peak power, for example.

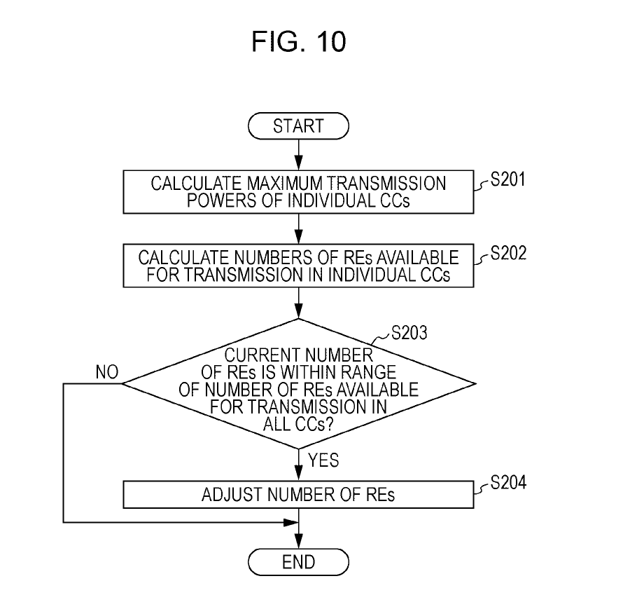

FIG. 10 is a flowchart illustrating a process of adjusting frequency resources according to this modification example. (Step S201) The transmission power control units 22-1 and 22-2 perform the process illustrated in FIG. 7 from the start to step S104 and calculate the maximum transmission powers P_{cc,1m} and P_{cc,2m} of the individual CCs (for example, 20 dBm (first CC) and 18 dBm (second CC)). The transmission power control units 22-1 and 22-2 output the calculated maximum transmission powers P_{cc,1m} and P_{cc,2m} of the individual CCs to the resource adjustment unit 24. After that, the process proceeds to step S202. (Step S202) The resource adjustment unit 24 calculates the numbers of REs available for transmission so that the numbers of REs are proportional to the maximum transmission powers P_{cc,1m} and P_{cc,2m} received from the transmission power control units 22-1 and 22-2. For example, it is assumed that the number of REs N_{RE1} available for transmission with a transmission power equal to or less than the maximum transmission power P_{cc,1m}=20 dBm in the first CC is preset to 20, and the transmission powers for the individual REs are equal. The resource adjustment unit 24 sets the number of REs N_{RE2} available for transmission using the second CC to the number of REs that is smaller than 20 by 2 dB, floor (N_{RE1}·10^{((Pcc,2m-Pcc,1m)/10)})=13. After that, the process proceeds to step S203.

(Step S203) The resource adjustment unit 24 determines whether or not the current number of REs is within the range of the calculated number of REs available for transmission in all the CCs. In a case where it is determined that the current number of REs is within the range of the number of REs available for transmission (YES in step S203), the process ends. In a case where it is determined that the current number of REs is out of the range of the number of REs available for transmission in at least one CC (NO in step S203), the process proceeds to step S204.

(Step S204) The resource adjustment unit 24 adjusts the number of REs so that the number of REs becomes within the range of the calculated number of REs available for transmission in all the CCs. For example, the resource adjustment unit 24 decreases the current number of REs in a certain CC by the number of REs that is an excess beyond the calculated number of REs available for transmission. In a case where there is another CC in which the current number of REs is smaller than the calculated number of REs available for transmission, the number of REs may be increased by distributing, for the other CC, all or some of the REs subtracted from the certain CC. After that, the process ends.

In this modification example, the process in the above-described step S201 may be performed by the resource adjustment unit 24 on the basis of the MPRs stored in the MPR holding unit 23. The description has been given above of a case where the resource adjustment unit 24 provided in the mobile station devices 21 and 21-2 performs a process related to adjustment of resources, but this modification example is not limited thereto. In this modification example, the base station devices 12-1 and 12-2 may perform a process related to adjustment of resources, and the numbers of frequency resources calculated by the base station devices 12-1 and 12-2 may be transmitted to the mobile station devices 21 and 21-2. In this case, the base station devices 12-1 and 12-2 respectively store MPRs for individual access schemes, and receive, from the mobile station devices 21 and 21-2, a maximum transmission power, the number of CCs that are being used, and the numbers of frequency resources for individual CCs.

The description has been given above of a case where transmission power control and resource adjustment are performed in consideration of MPR or CM, but this embodiment is not limited thereto. The transmission power control units 22-1 and 22-2 may perform transmission power control for individual CCs and the resource adjustment unit 24 may perform resource adjustment for individual CCs in consideration of path loss for each frequency, the path loss being used as an index value related to peak power instead of MPR or CM. Path loss is a ratio of power to reception sensitivity of a transmit signal. Path loss is proportional to the square to the fourth power of a frequency, and thus there is a probability that uniform reception quality is not obtained among CCs if resource adjustment is not performed. Therefore, resource adjustment is performed in consideration of path loss for each frequency, so that uniform reception quality can be obtained among CCs.

In this way, according to this embodiment, in a case where access schemes in which the flatness of a power spectrum of a transmit signal varies are used for any of CCs in CA, transmission power control or resource adjustment is performed in consideration of an index value related to peak power for each access scheme, for example, MPR. Accordingly, degradation of transmission quality can be prevented, and the system can be stabilized.

### Third Embodiment

Next, regarding a third embodiment of the present invention, the same configuration or process is denoted by the same reference numeral, and the description thereof is given by quoting it from the first embodiment. This embodiment is an embodiment in which a MIMO (Multiple Input Multiple Output) technique is applied by using a plurality of antennas for each CC.

A communication system 3 (not illustrated) according to this embodiment includes a mobile station device 31 instead of the mobile station device 11 of the communication system 1 (see FIG. 1).

### (Configuration of Mobile Station Device)

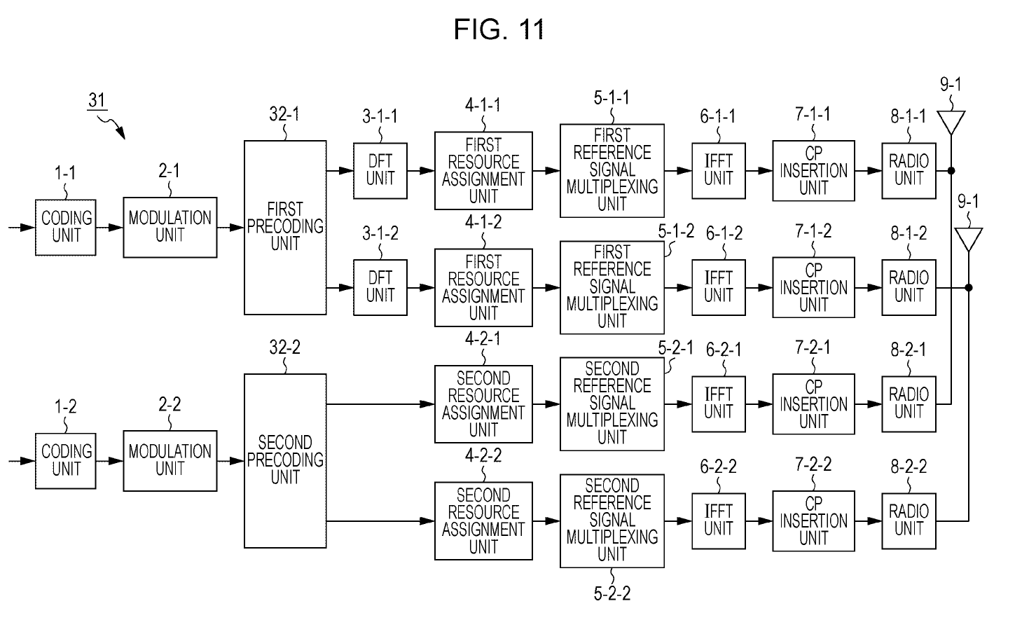

FIG. 11 is a schematic diagram illustrating the configuration of the mobile station device 31 according to this embodiment.

FIG. 11 illustrates an example configuration of the mobile station device 31 including two antennas 9-1 and 9-2. In FIG. 11, reference numeral x-y-1 or the like indicates the same configuration as a configuration denoted by reference numeral x-y in FIG. 1. “-1” or the like at the end of reference numeral x-y−1 or the like indicates a configuration for performing a process of generating a radio signal to be transmitted from the antenna 9-1 or the like.

Therefore, the configurations of a DFT unit 3-1-1, a first resource assignment unit 4-1-1, a first reference signal multiplexing unit 5-1-1, an IFFT unit 6-1-1, a CP insertion unit 7-1-1, and a radio unit 8-1-1 are the same as the configurations of a DFT unit 3-1-2, a first resource assignment unit 4-1-2, a first reference signal multiplexing unit 5-1-2, an IFFT unit 6-1-2, a CP insertion unit 7-1-2, and a radio unit 8-1-2, respectively, across the antennas.

Also, the configurations of a second resource assignment unit 4-2-1, a second reference signal multiplexing unit 5-2-1, an IFFT unit 6-2-1, a CP insertion unit 7-2-1, and a radio unit 8-2-1 are the same as the configurations of a second resource assignment unit 4-2-2, a second reference signal multiplexing unit 5-2-2, an IFFT unit 6-2-2, a CP insertion unit 7-2-2, and a radio unit 8-2-2, respectively, across the antennas.

The mobile station device 31 includes precoding units for individual CCs and receives modulation signals for the individual CCs. The precoding units each generate an output signal for a corresponding antenna. Here, the mobile station device 31 includes a first precoding unit 32-1 for the first CC 13-1 and a second precoding unit 32-2 for the second CC 13-2.

The first precoding unit 32-1 and the second precoding unit 32-2 respectively perform layer mapping processing on modification signals received from the modulation units 2-1 and 2-2, and multiply the signals that have undergone layer mapping processing by a precoding matrix. The first precoding unit 32-1 and the second precoding unit 32-2 respectively output output signals, which have been obtained through multiplication by a precoding matrix, to the DFT units 3-1-1 and 3-1-2 and the second resource assignment units 4-2-1 and 4-2-2.

The radio units 8-1-1 and 8-2-1 output radio signals respectively generated thereby to the antenna 9-1. The radio units 8-1-2 and 8-2-2 output radio signals respectively generated thereby to the antenna 9-2.

The first precoding unit 32-1 and the second precoding unit 32-2 perform layer mapping by using different numbers of layers. The number of layers is also called the number of spatial multiplexing layers, and is an integer whose minimum value is 1 and whose maximum value is the number of antennas. In layer mapping, an input signal is multiplied by a unitary matrix having a rank of the same number as the number of layers, so as to perform S/P (Serial-to-Parallel) conversion, and thereby output signals, the number of which is the same as the number of antennas (2 in the example in FIG. 11), are generated.

Here, a smaller number of layers are assigned for layer mapping in which a single-carrier transmission scheme such as the DFT-S-OFDM scheme is used as an access scheme, whereas a larger number of layers are assigned for layer mapping in which a multi-carrier transmission scheme such as the OFDM is used as an access scheme. This is because a multi-carrier transmission scheme in which carriers of a plurality of frequency bands are used is more preferable for multiplexing a transmit signal in MIMO than a single-carrier transmission scheme.

For example, the first precoding unit 32-1 performs layer mapping with one layer. That is, the first precoding unit 32-1 multiplies each sample value of an input signal by a matrix of two rows and one column, so as to calculate two output signals having a mutual relationship of constant multiple.

On the other hand, the second precoding unit 32-2 performs layer mapping with two layers, for example. Here, the second precoding unit 32-2 multiplies each sample value of an input signal by a matrix of two rows and two columns, so as to calculate two output signals that are dependent of each other. This is because the OFDM scheme used in the second CC deals with a plurality of inputs and outputs dependent of one another, and has higher compatibility with MIMO, which is suitable for processing in high-order layers, than the DFT-S-OFDM scheme, so that favorable transmission characteristics can be obtained.

The first precoding unit 32-1 and the second precoding unit 32-2 each multiply, by a precoding matrix, two rows of input vectors having sample values of the two output signals generated through layer mapping as elements, and thereby calculate two rows of output vectors. The first precoding unit 32-1 and the second precoding unit 32-2 each generate output signals having element values of the calculated output vectors as sample values, and output the generated output signals to the DFT units 3-1-1 and 3-1-2 or the second resource assignment units 4-2-1 and 4-2-2.

In this embodiment, in a case where different access schemes are used for individual CCs, layer mapping is performed by using the number of layers that varies among the access schemes. Here, the number of layers for a multi-carrier access scheme (frequency division multiplexing scheme) that is more suitable for multiplexing is set to be larger than the number of layers for a single-carrier scheme (frequency spread scheme). Accordingly, degradation of quality in MIMO can be decreased in the entire system.

Part of the mobile station devices 11, 21, 21-2, and 31 according to the above-described embodiments, for example, the coding units 1-1 and 1-2, the modulation units 2-1 and 2-2, the DFT units 3-1, 3-1-1, and 3-1-2, the first resource assignment units 4-1, 4-1-1, and 4-1-2, the second resource assignment units 4-2, 4-2-1, and 4-2-2, the first reference signal multiplexing units 5-1, 5-1-1, and 5-1-2, the second reference signal multiplexing units 5-2, 5-2-1, and 5-2-2, the IFFT units 6-1, 6-1-1, 6-1-2, 6-2, 6-2-1, and 6-2-2, the CP insertion units 7-1, 7-1-1, 7-1-2, 7-2, 7-2-1, and 7-2-2, the transmission power control units 22-1 and 22-2, the MPR holding unit 23, the resource adjustment unit 24, the first precoding unit 32-1, and the second precoding unit 32-2 may be implemented by a computer. In this case, a program for implementing this control function may be recorded on a computer-readable recording medium, and the program recorded on the recording medium may be loaded into a computer system and executed thereby. Here, the “computer system” is a computer system built in the mobile station devices 11, 21, 21-2, and 31, and includes hardware devices such as an OS and peripheral devices. The “computer-readable recording medium” is a portable medium such as a flexible disk, a magneto-optical disk, a ROM, or a CD-ROM, or a storage device such as a hard disk built in the computer system. Further, the “computer-readable recording medium” may include a medium that dynamically holds the program for a short time, such as a communication link used for transmitting the program via a network such as the Internet or a communication line such as a telephone line, and a medium that holds the program for a certain period, such as a volatile memory inside the computer system serving as a server or a client in that case. Also, the foregoing program may be used to implement part of the above-described function, and may be used to implement the above-described function in combination with a program already recorded in the computer system.

Alternatively, a part or the entire part of the mobile station devices 11, 21, 21-2, and 31 according to the above-described embodiments may be implemented as an integrated circuit, such as an LSI (Large Scale Integration). The individual functional blocks of the mobile station devices 11, 21, 21-2, and 31 may be implemented by individual processors, or some or all of the functional blocks may be integrated into a processor. The form of the integrated circuit is not limited to the LSI, and a dedicated circuit or a multi-purpose processor may be used. In a case where an integration technique that replaces the LSI emerges due to the advance of semiconductor technologies, an integrated circuit based on the technique may be used.

An embodiment of the present invention has been described in detail with reference to the drawings. The specific configuration thereof is not limited to that described above, and various design changes can be made without deviating from the gist of the present invention.

### REFERENCE SIGNS LIST

1, 2, 3 communication system
11, 21, 21-2, 31 mobile station device
12-1, 12-2 base station device
1-1, 1-2 coding unit
2-1, 2-2 modulation unit (modulator)
3-1, 3-1-1, 3-1-2 DFT unit (discrete Fourier transformer)
4-1, 4-1-1, 4-1-2 first resource assignment unit
4-2, 4-2-1, 4-2-2 second resource assignment unit
5-1, 5-1-1, 5-1-2 first reference signal multiplexing unit (first reference signal multiplexer)
5-2, 5-2-1, 5-2-2 second reference signal multiplexing unit (second reference signal multiplexer)
6-1, 6-2, 6-1-1, 6-1-2, 6-2-1, 6-2-2 IFFT unit (inverse fast Fourier transformer)
7-1, 7-2, 7-1-1, 7-1-2, 7-2-1, 7-2-2 CP insertion unit
8-1, 8-2, 8-1-1, 8-1-2, 8-2-1, 8-2-2 radio unit
9, 9-1, 9-2 antenna unit (antenna)
22-1, 22-1 transmission power control unit (transmission power controller)
23 MPR holding unit
24 resource adjustment unit (resource adjuster)
32-1 first precoding unit
32-2 second precoding unit

1.-10. (canceled)

11. A transmission device comprising:
an antenna configured to transmit, to a first transmission device, a first data signal using a first transmission scheme and a first component carrier and to configured to transmit, to a second transmission device, a second data signal using a second transmission scheme and a second component carrier, wherein each of the first component carrier and the second component carrier is one of a plurality of frequency bands for carrier aggregation; wherein
the first transmission scheme differs from the second transmission scheme.

12. The transmission device according to claim 11, wherein the first transmission scheme is a discrete Fourier transform spread orthogonal frequency division multiplexing (DFT-S OFDM) scheme or a Clustered DFT-S-OFDM scheme, and the second transmission scheme is an Orthogonal Frequency Division Multiplexing (OFDM) scheme.

13. The transmission device according to claim 11, wherein a bandwidth of the first component carrier differs from a bandwidth of the second component carrier.

14. The transmission device according to claim 11, further comprising:
a controller configured to control first transmission power for transmitting the first data signal using the first component carrier and configured to control second transmission power for transmitting the second data signal using the second component carrier.

15. A transmission method for transmitting a signal, the method comprising:
transmitting, to a first transmission device, a first data signal using a first transmission scheme and a first component carrier; and
transmitting, to a second transmission device, a second data signal using a second transmission scheme and a second component carrier; wherein
each of the first component carrier and the second component carrier is one of a plurality of frequency bands for carrier aggregation, and
the first transmission scheme differs from the second transmission scheme.
